(19) United States
(12) Patent Application Publication
(10) Pub. No.: US 2002/0035524 A1
(43) Pub. Date: Mar. 21, 2002

(54) System and method for monitoring inventory amounts and locations

(76) Inventor: Martin Husslage, Rye, NH (US)

Correspondence Address: Martin Husslage, 446 Central Rd, Rye, NH, 03870, US

(21) Appl. No.: 09/956,881

(22) Filed: Sep. 21, 2001

Related U.S. Application Data
(60) Provisional application No. 60/234,259, filed on Sep. 21, 2000.

(51) Int. Cl. G06F 17/60

(52) U.S. Cl. 705/28

(57) ABSTRACT

System and method for monitoring exact product inventory amounts and locations with a reusable, programmable tag operating to provide digital location and amount information packets for a given item, and a software program operating to process the digital information packets providing individuals and other systems instant location and amount information for a specific item. A preferred embodiment includes a removable tag device comprised of temperature, weight sensing, radio frequency identification, memory and central processing devices. The tag operates to capture the then current weight, location and temperature of the item it is affixed to and creates a digital information packet including the identification, current weight, location and temperature of the item it is attached to. The digital information packet is transmitted at the request of the software program or at such a time the item has changed locations The preferred embodiment further includes a software program which converts the digital information packets to calculate the location and amount of all inventoried items within a company's storage, manufacturing, transportation and retail facilities. The software program can be integrated with external systems using a neutral file format for import and export. The software program can be used to indicate the location and amount of all inventoried items within a company's storage, manufacturing, transportation and retail facilities to an individual or existing information systems.

### CROSS REFERENCE TO RELATED APPLICATIONS

This present application takes priority over US provisional patent application Ser. No. 60/234,259 filed Sep. 21, 2000, titled System and Method for Monitoring Product Inventory. Named applicant Martin Husslage.

### FIELD OF THE INVENTION

This invention relates to inventory management and tracking solutions.

More particularly this invention relates to the tracking of the exact location and determination of the exact amount of inventoried products on hand at any point in time.

### BACKGROUND OF THE INVENTION

This invention relates generally to the field of inventory management, and more particularly to a system and method for monitoring exact product inventory amounts and locations and providing that information to individuals and information systems.

Inventory solutions started as a totally manual operation involving an individual or groups of individuals physically counting or weighing all the items in the company's storage, manufacturing and retail facilities. Those items that were in transit were added to the count upon arrival at one of the facilities.

With the implementation of computers and enterprise resource planning software, inventory levels are managed by theoretical levels calculated by the software based on the starting inventory less the materials required to complete the orders booked. Most companies using this method still employ a periodic physical inventory count to reconcile the theoretical amount with the actual amount of an item on hand.

Some solutions have employed bar code scanning and RFID tags to aid in the inventory process.

Bar codes contain information about an item. The bar code is either printed on the item or a sticker containing the bar code is affixed to the item. A fixed or mobile bar code reader is used to capture the information on the tag. The operator of the bar code reader also has the option of entering location information when scanning a code. The information captured by the bar code reader can be transmitted to fixed receivers indicating location information of the item. The information is then processed by the inventory software to calculate the total quantity of a specific item and its location.

Recently RFID tags containing information about an item have been affixed to or embedded in the item. Stationary or mobile readers collect the information contained in the tags. The information is then processed by the inventory software calculating the total quantity of a specific item and its location.

The primary deficiencies in the manual method of inventory control are that it is time consuming and cost prohibitive to maintain accurate levels of inventory at all times.

The primary deficiencies in the theoretical method of inventory control are that it cannot accurately compensate for wastage of an inventoried item. Intermittent manual inventory amounts must be taken periodically to reconcile the actual amount with the theoretical amount.

The primary deficiencies in the bar code and RDIF methods of inventory control are that these solutions cannot calculate the amount of an item remaining in the item's container. The methods only provide identification information about the item. These methods provide no information about the actual amount of an item contained within the package the tag is attached to.

### SUMMARY OF THE INVENTION

The primary object of the invention is to provide instant, accurate location and current amount information of inventoried products throughout a company's storage, manufacturing, transportation and retail facilities worldwide.

Another object of the invention is to provide a method of communicating the location and levels of inventory on hand to individuals and existing information systems.

Other objects and advantages of the present invention will become apparent from the following descriptions, taken in connection with the accompanying drawings, wherein, by way of illustration and example, an embodiment of the present invention is disclosed.

System and method for monitoring exact product inventory amounts and locations comprising: a reusable, programmable tag operating to provide digital information packets containing location and amount information for a given item, and a software program operating to process the digital information packets providing users and other systems instant location and amount information for tagged items.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWINGS

FIG. 1 is a flow chart of the operations that comprise the method.

FIG. 2 is a plan view of a typical inventory storage area.

FIG. 3 is a plan view of a typical manufacturing area.

FIG. 4 is a plan view of the typical transportation method.

FIG. 5 is a schematic diagram illustrating the operation of a portion of the invention.

FIG. 6 is a perspective view of the preferred embodiment of a tag, which can be affixed to round containers.

FIG. 7 is a perspective view of the preferred embodiment of a tag that can be affixed to round containers employing a polymer-based, weight-sensing device.

FIG. 8 is a plan and sectional view of the preferred embodiment of a tag that can be affixed to different sized square and rectangular containers.

FIG. 9 is a perspective view of the preferred embodiment of a tag that that is embedded into a container.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

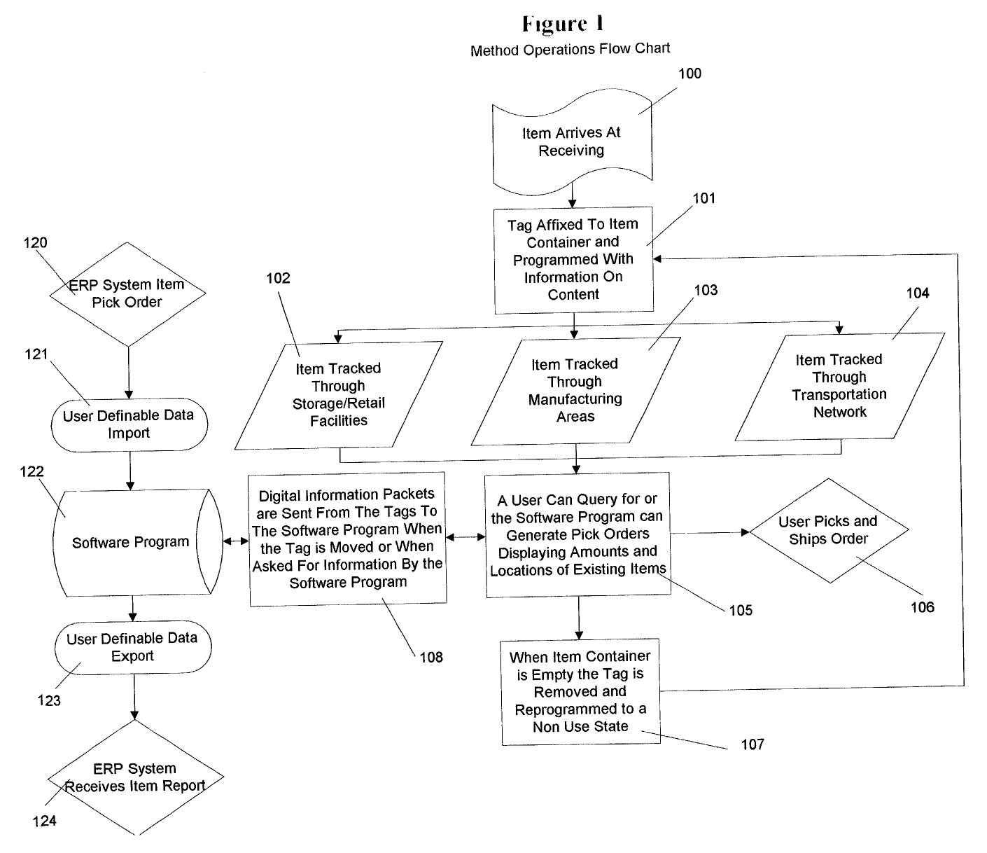

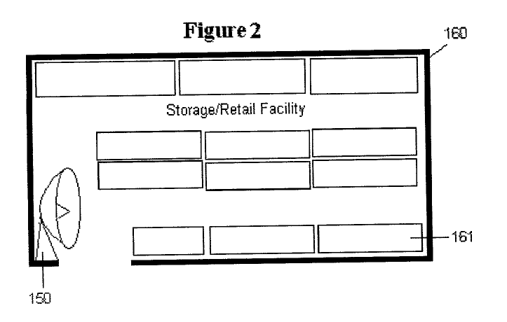

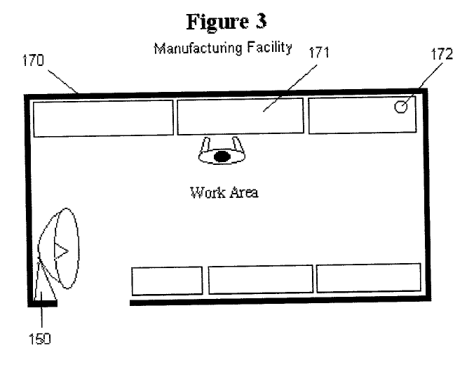

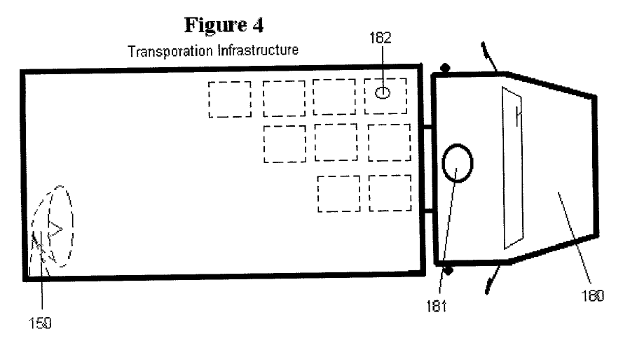

A system and method for monitoring exact product inventory amounts and locations is described in FIGS. 1-8.

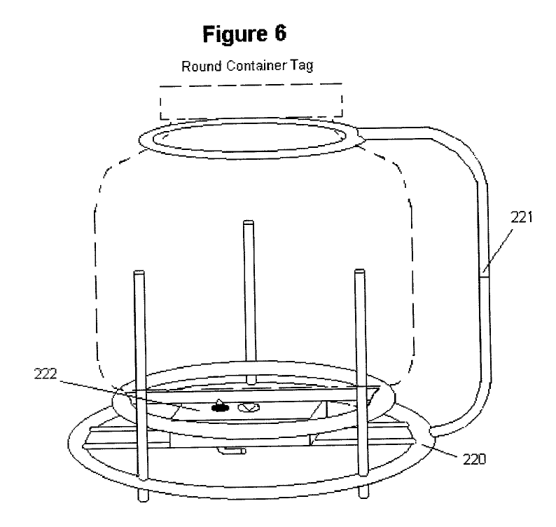

The invention is used to track the location and amounts of an item from the time it is received by a company to the time it has been consumed as described in FIG. 1. When an inventoried item is received a reusable, programmable tag, such as the types, but not limited to those in FIGS. 6-8, are affixed to the item's container. The tag is programmed 100 with the item's identification information. The item is then placed in a company's storage/retail facilities 102, manufacturing areas 103, transportation infrastructure 104.

When an item is moved from one location another it transmits 108 a digital information packet containing identification, weight and temperature information which is received by a uniquely identified antenna 150 placed throughout a company's infrastructure. The digital information packet is processed by the software program 122 and logs the location and amount of the item.

The software program can receive information from an existing information system 120 and import that information in a user defined format 121 for storage or processing. The software program 122 can create pick orders 105 indicating the required items, amounts and locations. The software program 122 can be queried 155 to display the amounts and locations of an item. The item is then picked and processed 106.

When the container of an item is empty of the item, the tag is removed from the container and re-programmed to a non-use state 107.

Each of the antenna 150 placed within a company's storage/retail 160, manufacturing 170, transportation 180 infrastructure contain a unique ID. Each unique ID represents a defined location within the company's infrastructure to the software program 122.

When items 161 are placed in a company's storage/retail facility 160 the tag will send a digital information packet to be received by the nearest antenna 150. The digital information packet is sent to the software program 122 that computes the location and amount of the item.

When items 172 are placed in a company's manufacturing facilities 170 the tag will send a digital information packet to be received by the nearest antenna 150. The digital information packet is sent to the software program 122 that computes the location and amount of the item.

When items 182 are placed in a company's transportation infrastructure 180 the tag will send a digital information packet to be received by the nearest antenna 150. The digital information packet is sent to the software program 122 that computes the location and amount of the item.

The digital information packets captured by the antenna are transmitted to the software program 122 by but not limited to LAN, WAN, RF and any other means the company may employ for the transmission of digital information, to the software program 122.

The software program 122 can initiate a procedure to send instructions through the antenna 150 to the RF send /receive unit 203 of the tag instructing the central processor 200 to create digital information packet to send by the RF send /receive unit 203 to the antenna 150 and back to the software program 122 allowing the software program 122 to compute a then current inventory of items, amounts and locations.

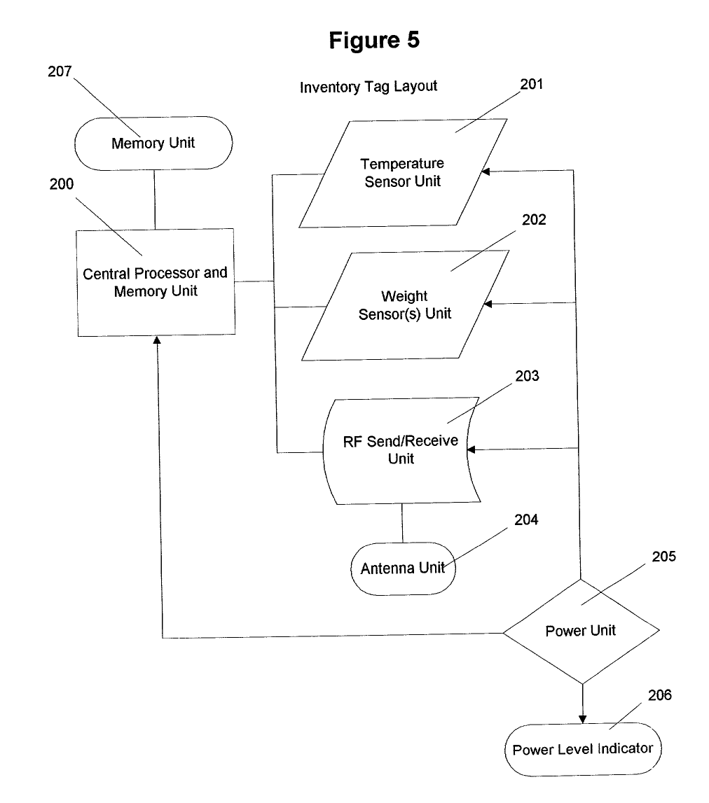

Each inventory tag comprises a number of devices to capture and store information as described in FIG. 5. In the preferred embodiment the circuitry of the tag consists of a central processing device 200 which contains the logic of the tag portion of the invention, a memory device 207 which can be reprogrammed with the identity information of the item the tag is attached to, a temperature sensing device 201 which determines the temperature of area in which the item exists, a, or multiple of weight sensing devices 202 which capture the current weight of the item, a radio frequency send and receive device 203 for communication with the software program, a power device 205 which provides power for all devices in the inventory tag, and a Power Level Indicator device 206 which indicates a tags low power level to the software program as well as an audible and visual indication from the tag itself.

In the preferred embodiment of a tag to be affixed to cylindrical containers is described in FIG. 6. The structure of the tag 220 is affixed to the bottom of the inventory container. The circuitry of the devices described in FIG. 5 is positioned to determine the current weight and temperature of the item 222. A handle 221 can be adjusted to affix multiple size item containers to the tag.

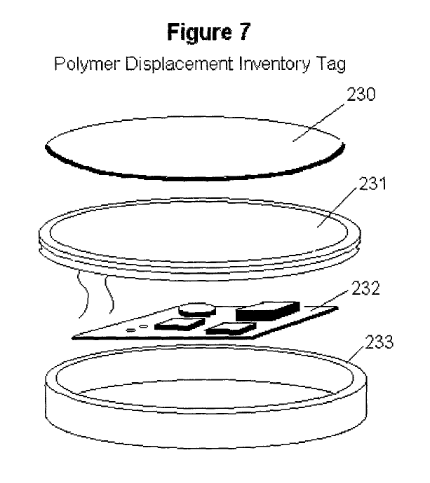

In the illustrated embodiment displayed in FIG. 7, a polymer displacement weight-sensing device 230 is affixed to a weight sensing device containment device 231 which is attached to the circuitry of the device 232 and supported by a base 233.

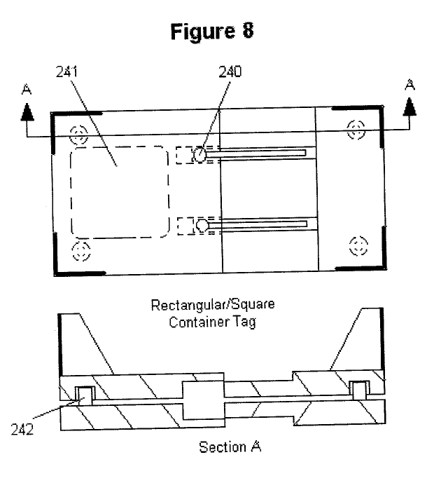

The preferred embodiment of the device illustrated in FIG. 8 is affixed to square and rectangular item containers. The device has adjustment mechanisms 240 which allow for a tag to be adjusted fitting on different sized item containers. The tag device contains the circuitry of the device 241. A single or multiple weight sensing devices 242 are placed about the tag to capture the then current weight of the item.

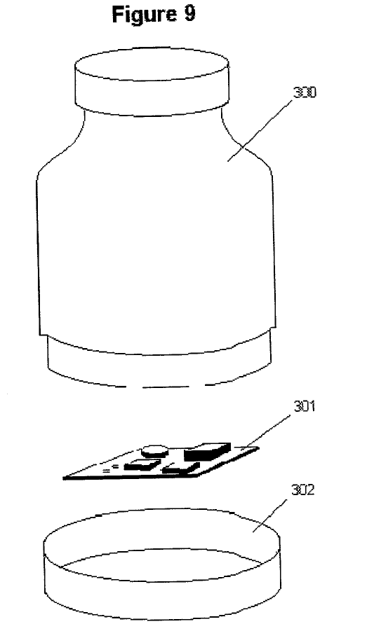

The preferred embodiment of the device illustrated in FIG. 9 shows that tag circuitry 301 embedded into a container 300. The container is comprised of a section that contains the item 300 and a base section 302 that contains the circuitry.

Thus it is seen that this invention provides instant, accurate location and current amount information of inventoried products throughout a company's storage, manufacturing, transportation and retail facilities world wide and that this invention provides a way of communicating the location and levels of inventory on hand to individuals and existing information systems.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. System and method for monitoring exact product inventory amounts and locations comprising:
A reusable, programmable tag operating to provide location and amount information packets for a given item; and
A software program operating to process information packets providing users and other information systems instant location and amount information for specific inventory items

2. System and method for monitoring exact product inventory amounts and locations as claimed in claim 1 further comprising a removable tag device operating to be affixed to an item.

3. System and method for monitoring exact product inventory amounts and locations as claimed in claim 1 further comprising a weight-sensing device or devices operating to indicate the current weight of the item the tag is affixed to.

4. System and method for monitoring exact product inventory amounts and locations as claimed in claim 1 further comprising a temperature sensing device operating to indicate the current temperature of the area surrounding the item the tag is attached to.

5. System and method for monitoring exact product inventory amounts and locations as claimed in claim 1 further comprising a programmable memory unit operating to retain identification information about the item the tag is affixed to.

6. System and method for monitoring exact product inventory amounts and locations as claimed in claim 1 further comprising a central processing unit operating to convert information received from the weight and temperature sensing devices into digital signal packets.

7. System and method for monitoring exact product inventory amounts and locations as claimed in claim 1 further comprising a communication unit operating to send digital information packets and receive item identification information.

8. System and method for monitoring exact product inventory amounts and locations as claimed in claim 1 further comprising a power device operating to supply power to the electrical components contained within the tag.

9. System and met hod for monitoring exact product inventory amounts and locations as claimed in claim 1 further comprising a receiver operating to collect information packets sent from inventory tags.

10. System and method for monitoring exact product inventory amounts and locations as claimed in claim 1 further comprising a transmission unit operating to provide programming information to the programmable memory unit.

11. System and method for monitoring exact product inventory amounts and locations as claimed in claim 1 further comprising a software program operating to convert information packets into readable information indicating the amount and location of an item.

12. A system and method for monitoring exact product inventory amounts and locations as claimed in 1 further comprising of a software program operating to communicate that information with individuals and existing information programs.

13. System and method for monitoring exact product inventory amounts and locations as claimed in claim 2 wherein said tag is supplied in shapes and sizes to fit existing item containers.

14. System and method for monitoring exact product inventory amounts and locations as claimed in claim 2 wherein said tag contains the devices to provide the software system with the location and amount information of an item.

15. System and method for monitoring exact product inventory amounts and locations as claimed in claim 2 wherein said tag can be embedded in a container

16. System and method for monitoring exact product inventory amounts and locations as claimed in claim 3 wherein said weight sensing device may be one of many placed in locations about the tag to determine the current weight of the item.

17. System and method for monitoring exact product inventory amounts and locations as claimed in claim 5 wherein said programmable memory unit will be programmed to store identification information about the item the tag affixed to.

18. System and method for monitoring exact product inventory amounts and locations as claimed in claim 6 wherein said central processing unit contains the logic to convert the signals from the weight and temperature sensing devices into digital information packets.

19. System and method for monitoring exact product inventory amounts and locations as claimed in claim 6 wherein said central processing unit contains the logic to trigger the transmission of digital information packets.

20. A system and method for monitoring exact product inventory amounts and locations as claimed in claim 12 wherein said software program allows a user to define the content and format of information to import and export.
